(19) United States
(12) Patent Application Publication
(10) Pub. No.: US 2022/0118427 A1
(43) Pub. Date: Apr. 21, 2022

(54) USE OF CERIUM OXIDE FOR THE PREPARATION OF A LEAN NOX TRAP CATALYTIC COMPOSITION AND A METHOD OF TREATMENT OF AN EXHAUST GAS USING THE COMPOSITION

(71) Applicant: RHODIA OPERATIONS, Aubervilliers (FR)

(72) Inventors: Naotaka OHTAKE, Tokushima Prefecture (JP); Kaoru NISHIMURA, Tokushima-Ken (JP); Toshihiro SASAKI, Tokushima Prefecture (JP); Mitsuhiro OKAZUMI, Tokushima Prefecture (JP)

(21) Appl. No.: 17/417,449

(22) PCT Filed: Dec. 19, 2019
(86) PCT No.: PCT/EP2019/086206

§ 371 Date: Jun. 23, 2021

(30) Foreign Application Priority Data
Dec. 28, 2018 (EP) 18306865.9

(51) Int. Cl. B01J 23/10; B01J 37/08; B01J 35/10; B01J 23/44; B01J 27/232; B01D 53/94; F01N 3/20

(52) U.S. Cl. CPC B01J 23/10; B01J 37/082; B01J 35/1014; B01J 23/44; B01J 27/232; B01D 2255/1023; F01N 3/20; B01D 2255/2065; B01D 2255/9207; B01D 2255/1021; B01D 2255/2042; B01D 53/9422

(57) ABSTRACT

The present invention relates to the use of a resistant cerium oxide for the preparation of Lean NOx Trap catalytic composition. The invention also relates to such catalytic composition and to a method of treatment of an exhaust gas to decrease the NOx content using said catalytic composition.

The present application claims the priority of European patent application EP 18306865 filed on 28 Dec. 2018, the content of which being entirely incorporated herein by reference for all purposes. In case of any incoherency between the present application and the EP application that would affect the clarity of a term or expression, it should be made reference to the present application only.

The present invention relates to the use of a resistant cerium oxide for the preparation of Lean NOₓ Trap catalytic composition. The invention also relates to such catalytic composition and to a method of treatment of an exhaust gas to decrease the NOₓ content using said catalytic composition.

### BACKGROUND

Exhaust gas from vehicles powered by gasoline engines is typically treated with one or more three-way conversion (TWC) automotive catalysts, which are effective to abate NO, carbon monoxide (CO) and hydrocarbon (HC) pollutants in the exhaust of engines operated at or near stoichiometric air/fuel conditions. The precise proportion of air to fuel which results in stoichiometric conditions varies with the relative proportions of carbon and hydrogen in the fuel. An air-to-fuel (A/F) ratio of 14.65:1 (weight of air to weight of fuel) is the stoichiometric ratio corresponding to the combustion of a hydrocarbon fuel, such as gasoline, with an average formula CH_{1.88}. The symbol λ, is thus used to represent the result dividing a particular A/F ratio by the stoichiometric A/F ratio for a given fuel, so that λ=1 is a stoichiometric mixture, λ>1 is a fuel-lean mixture and λ<1 is a fuel-rich mixture.

Gasoline engines having electronic fuel injection systems provide a constantly varying air-fuel mixture that quickly and continually cycles between lean and rich exhaust. Recently, to improve fuel-economy, gasoline-fueled engine are being designed to operate under lean conditions. Lean conditions refers to maintaining the ratio of air to fuel in the combustion mixtures supplied to such engines above the stoichiometic ratio so that the resulting exhaust gases are “lean” i.e. the exhaust gases are relatively high in oxygen content. Leean burn gasoline direct injection (GDI) engines offer fuel efficiency benefits that can contribute to a reduction in greenhouse gas emissions carrying out fuel conibustion in excess air. A major by-product of lean combustion is NOₓ, the after-treatment of which remains a major challenge.

Emission of nitrogen oxides (NOₓ) must be reduced to meet emission regulation standards. TWC catalysts are not effective for reducing NOₓ emissions when the gasoline engine runs lean because of excessive oxygen in the exhaust. Two of the most promising technologies for reducing NOₓ under an oxygen-rich environment are urea selective catalytic reduction (SCR) and the lean NOₓ trap (LNT).

The LNT technology is based on the following principle. The exhaust of gasoline engines is treated with a Lean NOₓ Trap catalytic composition (or LNT catalytic composition) that contains several components, one of which being cerium oxide. This catalytic composition adsorbs the NOₓ released by the engine under lean exhaust conditions, releases the adsorbed NOₓ under rich conditions and reduces the adsorbed NOₓ to form N₂. The LNT catalytic composition contains an alkali or an alkali earth component (Ba, K, etc), which stores NOₓ during periods of lean (oxygen-rich) operations and releases the stored NOₓ during the rich (fuel rich) periods of operation. During periods of rich (or stoichiometric) operation, the catalytic composition promotes the reduction of NOₓ to nitrogen by reaction of NOₓ (including NOₓ released from the NOₓ sorbent) with HC, CO and/or hydrogen present in the exhaust gas. As the LNT catalytic composition weathers stringent conditions (high temperature, alternating atmosphere), the components of the catalytic composition needs to be resistant to such conditions.

To address this technical problem, the invention aims at providing a cerium oxide having a resistance to ageing under very stringent conditions (800° C. or 900° C. for 16 hours, under a gaseous atmosphere containing 10% by volume of O₂, 10% by volume of H₂O and the balance of N₂).

### Definitions

PGM designates a platinum group metal which is a chemical element selected from the group consisting of ruthenium, rhodium, palladium, osmium, iridium and platinum. The PGM may be selected from the group consisting of ruthenium, rhodium, palladium, iridium and platinum. It may also be selected from the group consisting of rhodium, platinum and palladium.

The inorganic oxide designates an inorganic oxide selected from the group consisting of alumina optionally stabilized by lanthanum and/or praseodymium; ceria; magnesia; silica; titania; zirconia; tantalum oxide; molybdenum oxide; tungsten oxide; and composite oxides thereof. The composite oxide may be silica-alumina, magnesia-alumina, ceria-zirconia or alumina-ceria-zirconia. The inorganic oxide may be more particularly selected from the group consisting of magnesia-alumina, alumina, or aluminum stabilized by lanthanum and/or praseodymium. An example of inorganic support material is alumina stabilized with 1.0% to 6.0 weight % of lanthanum, this proportion of lanthanum being expressed in lanthanum oxide.

The alkaline earth metal designates a chemical element selected from the group consisting of barium, calcium, strontium and magnesium. The alkali metal designates a chemical element selected from the group consisting of potassium, sodium, lithium and cesium.

It is specified that, in the continuation of the description, unless otherwise indicated, the values at the limits are included in the ranges of values which are given. This applies also to the expressions comprising “at least” or “at most”.

The term “specific surface area (BET)” is understood to mean the BET specific surface area determined by nitrogen adsorption. The specific surface area is well-known to the skilled person and is measured according to the Brunauer-Emmett-Teller method. This method was described in the periodical “The Journal of the American Chemical Society, 60, 309 (1938)”. The method used is also disclosed in standard ASTM D 3663-03 (reapproved 2008). In practice, the specific surface areas (BET) may be determined automatically with the appliance Flowsorb II 2300 or the appliance Tristar 3000 of Micromeritics according to the guidelines of the constructor. They may also be determined automatically with a Macsorb analyzer model I-1220 of Mountech according to the guidelines of the constructor. Prior to the measurement, the samples are degassed under vacuum and by heating at a temperature of at most 200° C. to remove the adsorbed volatile species. More specific conditions may be found in the examples.

As usual in the field of oxides, the concentrations of the solutions of cerium are expressed in terms of CeO₂. See page 13 and the examples.

### DESCRIPTION

The invention relates to the use of cerium oxide as defined in one of claims 1 to 12. More particularly, the invention relates to the use of cerium oxide for the preparation of a lean NOₓ trap catalytic composition, the cerium oxide exhibiting:
a specific surface area (BET) after ageing at 800° C. for 16 hours, under a gaseous atmosphere containing 10% by volume of O₂, 10% by volume of H₂O and the balance of N₂, of at least 75 m²/g, more particularly of at least 76 m²/g, even more particularly of at least 77 m²/g; or
a specific surface area (BET) after ageing at 700° C. for 16 hours, under a gaseous atmosphere containing 10% by volume of O₂, 10% by volume of H₂O and the balance of N₂, of at least 97 m²/g, more particularly of at least 98 m²/g, even more particularly of at least 99 m²/g.

The invention also relates to a LNT catalytic composition as defined in one of claims 13 to 16. The LNT catalytic composition generally comprises:
the cerium oxide as defined above;
at least one platinum group metal (PGM);
at least one inorganic oxide;
at least one element (E) in the form of an oxide, an hydroxide and/or a carbonate, the element (E) being selected in the group consisting of the alkaline earth metals, the alkali metals or a combination thereof.

According to an embodiment, the LNT catalytic composition comprises:
a cerium oxide exhibiting:
   a specific surface area (BET) after ageing at 800° C. for 16 hours, under a gaseous atmosphere containing 10% by volume of O₂, 10% by volume of H₂O and the balance of N₂, of at least 75 m²/g, more particularly of at least 76 m²/g, even more particularly of at least 77 m²/g; or
   a specific surface area (BET) after ageing at 700° C. for 16 hours, under a gaseous atmosphere containing 10% by volume of O₂, 10% by volume of H₂O and the balance of N₂, of at least 97 m²/g, more particularly of at least 98 m²/g, even more particularly of at least 99 m²/g;

at least one platinum group metal (PGM);

at least one inorganic oxide;

at least one element (E) in the form of an oxide, an hydroxide and/or a carbonate, the element (E) being selected in the group consisting of the alkaline earth metals, the alkali metals or a combination thereof.

According to another embodiment, the LNT catalytic composition comprises:
a cerium oxide exhibiting:
   a reducibility rate r_{600° C.} between 8.0% and 12.0%, more particularly between 8.0% and 10.0%; and/or
   a reducibility rate r_{900° C.} between 20.0% and 25.0%, more particularly between 22.0% and 25.0%; and/or
   a reducibility rate r_{400° C.} between 1.5% and 2.0%, more particularly between 1.5% and 1.8%;
these reducibility rates being measured after calcination of the cerium oxide in air at a temperature of 900° C. for 4 hours;
at least one platinum group metal (PGM);
at least one inorganic oxide;
at least one element (E) in the form of an oxide, an hydroxide and/or a carbonate, the element (E) being selected in the group consisting of the alkaline earth metals, the alkali metals or a combination thereof.

The LNT catalytic composition comprises at least one PGM. The PGM is typically present on the inorganic oxide or on the combination of the cerium oxide, of the inorganic oxide and of the oxide, hydroxide or carbonate of the element (E). The proportion of the PGM may be between 0.1 and 10.0 weight %, more preferably between 0.5 and 5.0 weight %, most preferably 1.0 to 3.0 weight %. The PGM is preferably present in an amount between 1 to 100 g/ft³, more preferably 10 to 80 g/ft³, most preferably 20 to 60 g/ft³.

The catalytic composition comprises at least one inorganic oxide.

The catalytic composition comprises at least one element (E) selected in the group consisting of the alkaline earth metals, the alkali metals or a combination thereof. Because of its basic property, element (E) is capable of forming nitrates with the acidic nitrogen oxides present in the exhaust gas and of storing them in this way. Element (E) is in the form of an oxide, an hydroxide and/or a carbonate. Element (E) may be in the form of an oxyde such as barium oxide or magnesium oxide. This form of barium is usually preferred because it forms nitrates under lean conditions and releases the nitrates relatively easily under rich conditions. Element (E) may be in the form of a carbonate such as barium carbonate. The proportion of element (E) in the catalytic composition, expressed as weight of oxide, may be between 5.0 weight % and 40.0 weight %, more particularly between 5.0 weight % and 30.0 weight %.

Some specific LNT catalytic compositions may be found in the examples of U.S. Pat. No. 9,610,564, US 2018/0311647, U.S. Pat. No. 9,662,638 or US 2015/0352495. A specific LNT catalytic composition is as disclosed in example 3 of U.S. Pat. No. 9,610,564 and comprises cerium oxide (32.5 weight %), barium carbonate (22.5 weight %), magnesia (7.1 weight %), zirconia (3.6 weight %), platinum (0.8 weight %) and palladium (0.12 weight %) and γ-alumina (complement to 100%).

The LNT catalytic composition is generally in the form of a washcoat. The washcoat is applied on a support body. The support body may be a monolith made of ceramic, for example of cordierite, of silicon carbide, of alumina titanate or of mullite, or of metal, for example Fecralloy. The support body is usually made of cordierite exhibiting a large specific surface area and a low pressure drop. The support body may be more particularly a ceramic support in honeycomb form.

The washcoat layer(s) usually contain(s) the cerium oxide in an amount between 20.0 and 120.0 g/L, more particularly between 30.0 and 100.0 g/L, this amount being expressed in g CeO₂/volume in L of the washcoat layer.

An example of a LNT composition applied on a support body is composed of two catalytically active washcoat layers applied on a support body:
the lower washcoat later A comprising: a cerium oxide A; at least one element (E); and a PGM selected in the group consisting of Pt, Pd or Pt+Pd;
the upper washcoat layer B disposed atop the washcoat layer A comprising: a cerium oxide B; a PGM selected in the group consisting of Pt, Pd or Pt+Pd; and no alkaline earth metal compound;
   cerium oxide A and/or cerium oxide B being as defined above.

The proportions of cerium oxide A and of cerium oxide B are between 30.0 and 120.0 g/L, more particularly between 30.0 and 80.0 g/L. The washcoat layers A or B may comprise a combination of Pt and Pd. The molar ratio of platinum to palladium may be from 1:2 to 20:1, more particularly from 1:1 to 10:1. The washcoat layer A and/or washcoat layer B may optionally also comprise rhodium. Rhodium in this case is present especially in a proportion of 0.1 to 10.0 g/ft (corresponding to 0.003 to 0.35 g/L), based on the volume of the support body.

The LNT catalytic composition is prepared by techniques well-known in the art. The washcoat is applied on the body support or on another washcoat layer in the form of a preformed slurry of finely divided particles in water. The slurry typically contains between 5 to 70 weight %, more preferably between 10 to 50 weight %, of solid. The PGM is introduced in the form of a salt (e.g. a nitrate) or of a coordination compound (e.g. a malonate). An example of preparation of a washcoat is now disclosed. Al₂O₃.CeO₂.MgO.BaCO₃ composite material is formed by impregnating a mixture of Al₂O₃, CeO₂ and MgO with barium acetate and the slurry is spray-dried. The solid is then calcined in air at 650° C. for 1 hour. Then, a slurry of the calcined solid in water is milled to reduce the average particle size of the solid. To the slurry, a solution of Pt malonate and Pd nitrate are added and the mixture is stirred until it is homogeneous. The Pt/Pd is allowed to adsorb onto the solid for 1 hour. The final dispersion may be applied on a body support to form a washcoat. The washcoat is then dried and calcined in air at 500° C. for 2 hours. Other LNT catalytic compositions may be prepared according to the methods disclosed in the examples of U.S. Pat. No. 9,610,564, US 2018/0311647, U.S. Pat. No. 9,662,638 or US 2015/0352495.

Cerium oxide may be represented by formula CeO₂. The cerium oxide may comprise impurities such as residual nitrates or other rare-earth elements. The nitrates stem from the process used which is disclosed below. The other rare-earth elements are very often associated with cerium in the ores from which cerium is extracted and consequently also in solution S which is described below. The total amount of impurities in the cerium oxide is generally lower than 0.50% by weight, more particularly lower than 0.25% by weight, even lower than 0.20% by weight. The amounts of impurities are determined by well-known analytical techniques used in chemistry, such as microanalysis, X-ray fluorescence, Inductively Coupled Plasma Mass Spectrometry or inductively coupled plasma atomic emission spectroscopy.

The cerium oxide exhibits:
a specific surface area (BET) after ageing at 800° C. for 16 hours, under a gaseous atmosphere containing 10% by volume of O₂, 10% by volume of H₂O and the balance of N₂, of at least 75 m²/g, more particularly of at least 76 m²/g, even more particularly of at least 77 m²/g;
   or
a specific surface area (BET) after ageing at 700° C. for 16 hours, under a gaseous atmosphere containing 10% by volume of O₂, 10% by volume of H₂O and the balance of N₂, of at least 97 m²/g, more particularly of at least 98 m²/g, even more particularly of at least 99 m²/g.

The specific surface area (BET) after ageing at 800° C. for 16 hours, under a gaseous atmosphere containing 10% by volume of O₂, 10% by volume of H₂O and the balance of N₂, may be at most 80 m²/g. The specific surface area (BET) after ageing at 800° C. for 16 hours, under a gaseous atmosphere containing 10% by volume of O₂, 10% by volume of H₂O and the balance of N₂, may be between 75 and 80 m²/g, more particularly between 76 and 80 m²/g, even more particularly between 77 and 80 m²/g.

The specific surface area (BET) after ageing at 700° C. for 16 hours, under a gaseous atmosphere containing 10% by volume of O₂, 10% by volume of H₂O and the balance of N₂, may be at least 91 m²/g, more particularly at least 95 m²/g, even more particularly at least 97 m²/g, even more particularly at least 98 m²/g, even more particularly at least 99 m²/g.

The specific surface area (BET) after ageing at 700° C. for 16 hours, under a gaseous atmosphere containing 10% by volume of O₂, 10% by volume of H₂O and the balance of N₂, may be at most 102 m²/g, more particularly at most 100 m²/g. The specific surface area (BET) after ageing at 700° C. for 16 hours, under a gaseous atmosphere containing 10% by volume of O₂, 10% by volume of H₂O and the balance of N₂, may be between 91 and 102 m²/g, more particularly between 95 and 102 m²/g, even more particularly between 97 and 102 m²/g, even more particularly between 98 and 102 m²/g, even more particularly between 99 and 102 m²/g.

The specific surface area (BET) after ageing at 900° C. for 16 hours, under a gaseous atmosphere containing 10% by volume of O₂, 10% by volume of H₂O and the balance of N₂, may be at least 39, more particularly at least 45 m 2/g.

The specific surface area (BET) after ageing at 900° C. for 16 hours, under a gaseous atmosphere containing 10% by volume of O₂, 10% by volume of H₂O and the balance of N₂, may be at most 50 m²/g. The specific surface area (BET) after ageing at 900° C. for 16 hours, under a gaseous atmosphere containing 10% by volume of O₂, 10% by volume of H₂O and the balance of N₂, may be between 39 and 50 m²/g, more particularly between 45 and 50 m²/g.

The specific surface area (BET) after calcination in air at 900° C. for 4 hours may be at least 65 m²/g, more particularly at least 67 m²/g. The specific surface area (BET) after calcination in air at 900° C. for 4 hours may be at most 75 m²/g.

The specific surface area (BET) after calcination in air at 900° C. for 24 hours, may be between 40 and 60 m²/g, more particularly between 40 and 55 m²/g.

For the preparation of the LNT catalytic composition, the cerium oxide is used in the form of a powder. The particles of cerium oxide usually exhibit a mean size D50 between 0.2 μm and 10.0 μm. D50 is more particularly between 0.5 μm and 5.0 μm, even more particularly between 0.5 μm and 3.0 μm or between 1.0 μm and 3.0 μm. D50 may also be comprised between 0.5 μm and 1.8 μm, more particularly between 0.5 μm and 1.5 μm. The cerium oxide particles may exhibit a D10 between 0.05 μm and 4.0 μm, more particularly between 0.1 μm and 2.0 μm. The cerium oxide particles may exhibit a D90 between 1.0 μm and 18.0 μm, more particularly between 1.5 μm and 8.0 μm, even more particularly between 2.0 μm and 5.0 μm. D10, D50 and D90 (in μm) have the usual meaning used in statistics. Dn (n=10, 50 or 90) represents the particle size such that n % of the particles is less than or equal to the said size. D50 corresponds to the median value of the distribution. These parameters are determined from a distribution of size of the particles (in volume) obtained with a laser diffraction particle size analyzer. The appliance LA-920 of HORIBA, Ltd. may be used. Conditions disclosed in the examples may apply.

The cerium oxide exhibits an improved reducibility. Indeed, after calcination in air at a temperature of 900° C. for 4 hours, the cerium oxide is characterized by a reducibility rate r_{600° C.} between 8.0% and 12.0%, more particularly between 8.0% and 10.0%. After calcination in air at a temperature of 900° C. for 4 hours, it may also exhibit a reducibility rate r_{900° C.} between 20.0% and 25.0%, more particularly between 22.0% and 25.0%. After calcination in air at a temperature of 900° C. for 4 hours, it may exhibit a reducibility rate r_{400° C.} between 1.5% and 2.0%, more particularly between 1.5% and 1.8%.

The reducibility rates and the volumes of hydrogen consumed are determined from a TPR curve obtained by temperature programmed reduction (more details about this technique used to characterize catalysts may be found in “Thermal Methods”, chapter 18 of “Characterization of solid materials and heterogeneous catalysts”, Adrien Mekki-Berrada, isbn 978-3-527-32687-7 or in “Temperature programmed reduction and sulphiding”, chapter 11 of “An integrated approach to homogeneous, heterogeneous and industrial catalysis”, 1993, isbn 978-0-444-89229-4). The method consists in measuring the consumption of hydrogen as a function of temperature of a sample which is being heated under a flow of a reducing atmosphere composed of hydrogen (10.0 vol %) diluted in argon (90.0 vol %).

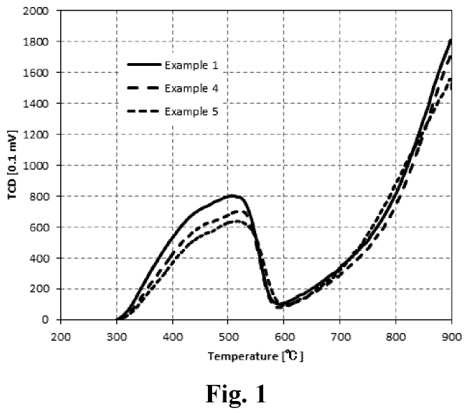

The hydrogen consumption is measured with a conductivity thermal detector (TCD) while the sample is heated in a controlled manner from the ambiant temperature to 900° C. under said reducing atmosphere. The measurement can be performed with a Hemmi Slide Rule TP-5000 appliance. The TPR curve gives the intensity of the signal (y axis) of the TCD as a function of the temperature of the sample (x axis). The TPR curve is the curve from 50° C. to 900° C. Examples of TPR curves are given on FIG. 1.

The reducibility rates envisioned in the present application are given by the following formulas:

red_{900° C.}=V_{H2 from 50° C. to 900° C.}/V_{theoretical}×100 (Ia)

red_{600° C.}=V_{H2 from 50° C. to 600° C.}/V_{theoretical}×100 (Ib)

red_{400° C.}=V_{H2 from 50° C. to 400° C.}/V_{theoretical}×100 (IC)

wherein:
V_{H2 from 50° C. to 900° C.} corresponds to the volume of hydrogen consumed by the cerium oxide between 50° C. and 900° C.;
V_{H2 from 50° C. to 600° C.} corresponds to the volume of hydrogen consumed by the cerium oxide between 50° C. and 600° C.;
V_{H2 from 50° C. to 400° C.} corresponds to the volume of hydrogen consumed by the cerium oxide between 50° C. and 400° C.;
V_{theoretical} corresponds to the theoretical amount of hydrogen that would be consumed by cerium oxide if it were fully reduced. Theoretically, 1 mol of Ce would consume ½ mol of H₂. Of course, in formulas (Ia), (Ib) and (Ic), all volumes are given under the same conditions of pressure and temperature.

The cerium oxide may be prepared by the process which comprises the following steps:

(a) an aqueous solution S comprising nitrates of Ce^{IV} and Ce^{III} is heated at a temperature between 90° C. and 140° C., the aqueous solution being characterized by a Ce^{IV}/total Ce molar ratio of at least 90.0%, more particularly of at least 94.0%, in order to obtain a suspension comprising a liquid medium and a precipitate;
(b) the liquid of the suspension obtained at the end of step (a) is partially removed and water, preferably deionized water, is added;
(c) the mixture obtained at the end of step (b) is heated at a temperature comprised between 100° C. and 180° C., more particularly between 100° C. and 140° C., wherein the mixture being heated is characterized by a molar ratio α=Ce^{III} in solution/total Ce which is strictly less than 6.0%;
(d) a basic compound is added to the suspension obtained at the end of step (c) so as to obtain a pH of at least 8.0;
(e) the liquid of the suspension obtained at the end of step (d) is partially removed;
(f) the suspension obtained at the end of step (e) is heated at a temperature comprised between 60° C. and 180° C., more particularly between 100° C. and 140° C.;
(g) an organic texturing agent is added to the suspension obtained at the end of step (f);
(h) the solid separated from the suspension obtained at the end of step (g) is calcined under air.

The aqueous solution S comprises nitrates of Ce^{IV} and Ce^{III}. The aqueous solution S is characterized by a molar ratio Ce^{IV}/total Ce of at least 90.0%, more particularly of at least 94.0% (total Ce=Ce^{IV}+Ce^{III}). The molar ratio Ce^{IV}/total Ce may be between 90.0% and 99.9%, more particularly between 94.0% and 99.9%. Measurement of the quantities of Ce^{III} and Ce^{IV} may be performed according to analytical techniques known to the skilled person (see e.g. “Ultraviolet Spectrophotometric Determination of Cerium (III)” of Greenhaus et al., Analytical Chemistry 1957, Vol. 29, No. 10).

The cerium nitrate used to prepare solution S may result from the dissolution of a cerium compound, such as cerium hydroxide, with nitric acid. It is advantageous to use a salt of cerium with a purity of at least 99.5%, more particularly of at least 99.9%. The cerium salt solution may be an aqueous ceric nitrate solution. This solution is obtained by reaction of nitric acid with an hydrated ceric oxide prepared conventionally by reaction of a solution of a cerous salt and of an aqueous ammonia solution in the presence of aqueous hydrogen peroxide to convert Ce^{III} cations into Ce^{IV} cations. It is also particularly advantageous to use a ceric nitrate solution obtained according to the method of electrolytic oxidation of a cerous nitrate solution as disclosed in FR 2570087. A solution of ceric nitrate obtained according to the teaching of FR 2570087 may exhibit an acidity of around 0.6 N.

The aqueous solution S may exhibit a total concentration Ce^{III}+Ce^{IV} between 10 g/L and 150 g/L expressed in terms of cerium oxide. For instance, a concentration of 225 g/L of cerium nitrate corresponds to 100 g/L of CeO₂. The aqueous solution is usually acid. The amount of H⁺ in the aqueous solution S may be from 0.01 and 1.0 N. The aqueous solution S contains Ce^{IV}, Ce^{III}, H⁺ and NO₃⁻. It may be obtained by mixing the appropriate quantities of nitrate solutions of Ce^{IV} and Ce^{III} and by optionally adjusting the acidity. Examples of aqueous solutions S are disclosed in examples 1-3.

In step (a), the aqueous solution S is heated at a temperature between 90° C. and 140° C., more particularly between 90° C. and 110° C., in order to obtain a suspension comprising a liquid medium and a precipitate. Without being bound by any theory, it is believed that the obtained precipitate is in the form of cerium hydroxide. In step (a), the temperature is comprised between 90° C. and 140° C., more particularly between 90° C. and 110° C. The duration of the heat treatment is usually between 10 minutes and 5 hours, preferably between 10 minutes and 2 hours, more preferably between 10 minutes and 60 minutes. Without wishing to be bound by any particular theory, the function of this heating step is to trigger a precipitation of a cerium-containing solid. The conditions of example 1 (100° C.; 30 min) may be used.

In step (b), the liquid of the suspension obtained at the end of step (a) is partially removed and water, preferably deionized water, is added. Removal of the liquid may be carried out, for example, by Nutsche filter method, centrifuging, filter pressing.

The liquid may also be conveniently removed by leaving the solid settle and by removal of the liquid on the top. This technique of leaving the solid settle and removing the liquid was applied in the examples 1-3. Similarly to what is disclosed in the examples 1-3, the following conditions may apply for step (b): the liquid of the suspension obtained at the end of step (a) is partially removed and water, preferably deionized water, is added, wherein the removal of liquid is performed after leaving the solid settle, the quantity of liquid removed being between 50% and 90%, more particularly between 60% and 80%, even more particularly between 70% and 80%, of the quantity of liquid present in the tank. This technique of leaving the solid settle and of removing the liquid is a convenient technique because there is no need to add any filter. Of course, the time needed to leave the solid settle in the bottom of the tank is variable and depends in particular on the size of the particles. The time needed should be such that the solid has settled enough in the tank so that the removal of liquid does not remove too much of solid to maintain a high yield of step (b).

The amount of liquid removed may be such that the decrease ratio R is between 10% and 90%, more particularly between 35% and 45%, R being defined by the following equation:

R=[anions] at the end of step (b)/[anions] at the end of step (a)[anions] being the concentration of the anions expressed in mol/L.

As the aqueous solution S contains substantially only nitrates as anions, R may conveniently be calculated by the following equation:

R=(F/G)/(D/E)×100

wherein:
D is the amount of NO₃⁻ (mol) at the end of step (a);
E is the volume (liter) of liquid at the end of step (a);
F is the amount of NO₃⁻ (mol) at the end of step (b);
G is the volume (liter) of liquid at the end of step (b).

F=D×removal ratio of the liquid medium

D may be estimated by the following equation:

D=A/172.12×[B/100×4+(100−B)/100×3]+C

wherein:
A is the amount of cerium cations in terms of CeO₂ (gram);
B is the percentage of tetravalent cerium cations per total cerium cations;
C is the quantity of nitrates (mol) other than the nitrates of Ce(NO₃)₃ and Ce(NO₃)₄.

A, B and C can be deduced from analysis of the aqueous solution S. An alternative method to determine D and R is to analyze the amount of the nitrate anions in the liquid medium with well-known analytical techniques such as ionic chromatography or adsorptiometry.

In step (c), the mixture obtained at the end of step (b) is heated at a temperature between 100° C. and 180° C., more particularly between 100° C. and 140° C. The conditions of example 1 (120° C.; 2 h) may be used. Ce(NO₃)₃ may optionally be added to the mixture before being heated. The mixture that is heated is characterized by a controlled amount of Ce^{III} in solution. Indeed, the molar ratio α=Ce^{III} in solution/total Ce needs to be strictly less than 6.0% (<6.0%). Total Ce is defined as the total amount of cerium (mol) present in the mixture whatever its form (e.g. ion, hydroxide, oxide). Moreover, it is expected that the resistance to ageing in hydrothermal conditions at 700° C. depends on this molar ratio. The molar ratio α is therefore preferably less than or equal to 3.0% (≤3.0%), more particularly less than or equal to 2.5% (≤2.5%). α is generally higher than or equal to 0.1%.

The duration of the heat treatment in step (c) is usually between 10 minutes and 48 hours, preferably between 1 hour and 3 hours.

In step (d), a basic compound is added to the suspension obtained at the end of step (c) so as to obtain a pH of at least 8.0, more particularly a pH between 8.0 and 9.5. This basic compound may be for example sodium hydroxide, potassium hydroxide, an aqueous ammonia solution, ammonia gas, or mixtures thereof. Ammonia solution is preferred as it is used conveniently and it provides ammonium nitrate as an effluent. An aqueous solution of ammonia with a concentration between 10 and 12 mol/L may conveniently be used. The function of the basic compound is to help precipitate the Ce^{III} cations which are still present in solution.

In step (e), the liquid of the suspension obtained at the end of step (d) is partially removed. Removal of the liquid may be carried out, for example, by Nutsche filter method, centrifuging, filter pressing.

As in the examples, the liquid may also conveniently be removed by leaving the solid settle followed by removal of the liquid on the top. This technique of leaving the solid settle and removing the liquid was applied in the examples 1-3. Similarly to what is disclosed in the examples 1-3, the following conditions are applied for step (e): the liquid of the suspension obtained at the end of step (d) is partially removed, wherein the removal of liquid is performed after leaving the solid settle, the quantity of liquid removed being between 20% and 60%, more particularly between 40% and 60%, of the quantity of liquid present in the tank. This technique of leaving the solid settle and of removing the liquid is a convenient technique because there is no need to add any filter. Of course, the time needed to leave the solid settle in the bottom of the tank is variable and depends in particular on the size of the particles. The time needed should be such that the solid has settled enough in the tank so that the removal of liquid does not remove too much of solid to maintain a high yield of step (e).

The amount of liquid removed may be such that the decrease ratio R′ is between 5% and 70%, more particularly between 45% and 55%, R′ being defined by the following equation:

R′=[total amount of ions (mol) at the end of step (e)/total amount of Ce (mol) at the end of step (e)]/[total amount of ions (mol) at the end of step (d)/total amount of Ce (mol) at the end of step (d)]

The total amount of Ce corresponds to the Ce present in the mixture at the end of step (d) or step (e) present in the mixture whatever its form. The cerium may be present in the form of an hydroxide (e.g. Ce^{III}(OH)₃ and/or Ce^{VI}(OH)₄) and/or oxyhydroxide (e.g. Ce_{VI}O_{2-X}H₂O).

The ions that are present at the end of step (d) or step (e) are the following ones: NO₃⁻, OH⁻ and the cation(s) associated to the basic compound(s) that has/have been added. These cations may be Na⁺, K⁺ or NH₄⁺. R′ may be also calculated by a mass balance and/or by analytical methods.

In step (f), the suspension obtained at the end of step (e) is heated at a temperature between 60° C. and 180° C., more particularly between 100° C. and 140° C. The duration of the heat treatment in step (f) is usually between 10 minutes and 5 hours, preferably between 30 min and 2 hours. The conditions of example 1 (120° C.; 1 h) may be used.

In step (g), an organic texturing agent (or “template agent”) is added to the suspension obtained in the preceding step (f). An organic texturing agent usually refers to an organic compound, such as a surfactant, able to control or modify the mesoporous structure of the cerium oxide. “Mesoporous structure” basically describes a structure which specifically comprises pores with an average diameter comprised between 2 and 50 nm, described by the term “mesopores”. Typically, these structures are amorphous or crystalline compounds in which the pores are generally distributed in random fashion, with a very wide pore-size distribution.

The organic texturing agent may be added directly or indirectly. It can be added directly to the suspension. It can also be first added in a composition, for instance comprising a solvent of the organic texturing agent, and said composition being then added to the suspension.

The amount of organic texturing agent which is added, expressed as percentage by weight of additive relative to the weight of CeO₂, is generally between 5% and 100%, more particularly between 15% and 60%, preferably between 20% to 30%. The amount may be as in example 1 (texturing agent/CeO₂=25% by weight).

The organic texturing agent is preferably chosen in the group consisting of: anionic surfactants, nonionic surfactants, polyethylene glycols, carboxylic acids and their salts, and surfactants of the carboxymethylated fatty alcohol ethoxylate type. With regard to the organic texturing agent, reference may be made to the teaching of application WO-98/45212 and the surfactants described in this document may be used.

As surfactants of anionic type, mention may be made of ethoxycarboxylates, ethoxylated fatty acids, sarcosinates, phosphate esters, sulfates such as alcohol sulfates, alcohol ether sulfates and sulfated alkanolamide ethoxylates, and sulfonates such as sulfosuccinates, and alkylbenzene or alkylnapthalene sulfonates.

As nonionic surfactants, mention may be made of acetylenic surfactants, alcohol ethoxylates, alkanolamides, amine oxides, ethoxylated alkanolamides, long-chain ethoxylated amines, copolymers of ethylene oxide/propylene oxide, sorbitan derivatives, ethylene glycol, propylene glycol, glycerol, polyglyceryl esters and ethoxylated derivatives thereof, alkylamines, alkylimidazolines, ethoxylated oils and alkylphenol ethoxylates. Mention may in particular be made of the products sold under the brands Igepal®, Dowanol®, Rhodamox® and Alkamide®.

With regard to the carboxylic acids, it is in particular possible to use aliphatic monocarboxylic or dicarboxylic acids and, among these, more particularly saturated acids. Fatty acids and more particularly saturated fatty acids may also be used. Mention may thus in particular be made of formic acid, acetic acid, propionic acid, butyric acid, isobutyric acid, valeric acid, caproic acid, caprylic acid, capric acid, lauric acid, myristic acid and palmitic acid. As dicarboxylic acids, mention may be made of oxalic acid, malonic acid, succinic acid, glutaric acid, adipic acid, pimelic acid, suberic acid, azelaic acid and sebacic acid. Salts of the carboxylic acids may also be used, in particular the ammonium.

The organic texturing agent may more particularly be lauric acid or ammonium laurate.

Finally, it is possible to use a surfactant which is selected from those of the carboxymethylated fatty alcohol ethoxylate type.

The expression “product of the carboxymethylated fatty alcohol ethoxylate type” is intended to mean products consisting of ethoxylated or propoxylated fatty alcohols comprising a —CH₂—COOH group at the end of the chain.

These products may correspond to the formula:

R₁—O—(CR₂R₃—CR₄R₅—O)ₙ—CH₂—COOH

in which R₁ denotes a saturated or unsaturated carbon-based chain of which the length is generally at most 22 carbon atoms, preferably at least 12 carbon atoms; R₂, R₃, R₄ and R₅ may be identical and may represent hydrogen or else R₂ may represent an alkyl group such as a CH₃ group and R₃, R₄ and R₅ represent hydrogen; n is a non-zero integer that may be up to 50 and more particularly between 5 and 15, these values being included. It will be noted that a surfactant may consist of a mixture of products of the formula above for which R₁ may be saturated or unsaturated, respectively, or alternatively products comprising both —CH₂—CH₂—O— and −C(CH₃)═CH₂—O— groups.

Steps (a)-(g) may be performed in any vessel without critical limitation, and either a sealed vessel or an open vessel may be used. Specifically, an autoclave reactor may preferably be used. All steps (a)-(g) may be performed in the same vessel.

In step (h), the solid separated from the suspension obtained at the end of step (g) is calcined under air. Calcination is performed at a temperature of at least 300° C. The temperature may be between 300° C. and 900° C., more particularly between 300° C. and 450° C. The duration of the calcination may suitably be determined depending on the temperature, and may preferably be between 1 and 20 hours. The conditions of example 1 (400° C., 10 hours) may be used.

Step (h) may optionally be followed by step (i) which consists in sieving the cerium oxide particles obtained at the end of step (h). The benefits of step (i) is to remove the largest particles from the cerium oxide particles and also to improve the flowability of the powder.

### EXPERIMENTAL PART

After the calcination of step (h) (of after step (i) if any), the cerium oxide particles are tested as they are without any additional treatment.

### Specific Surface Areas

The specific surface areas (BET) by adsorption of N₂ are determined automatically on a Flowsorb II 2300 or a Macsorb analyzer model I-1220 (Mountech Co., LTD.). Prior to any measurement, the samples are carefully degassed to desorb any adsorbed volatile species such as H₂O. To do so, the samples may be heated at 200° C. for 2 hours in a stove, then at 300° C. for 15 min in the cell.

### Measurement of D10, D50 and D90

These parameters are determined from a distribution of size of the particles (in volume) obtained with a laser diffraction particle size analyzer. Appliance LA-920 of HORIBA was used. The particles are dispersed in water.

### Temperature Programmed Reduction (TPR)

TPR curves are obtained with a temperature programmed desorption analyzer manufactured by Hemmi Slide Rule Co., LTD. with a carrier gas containing by volume 90% argon and 10% hydrogen, at a gas flow rate of 30 ml/min. The heating rate of the sample (0.5 g) is 13.3° C./min. The TPR curves are obtained on samples which have been calcined under air at 900° C. for 4 hours.

### Hydrothermal Conditions at 800° C./16 h

The cerium oxide particles are aged at 800° C. for 16 hours under a gaseous atmosphere containing 10% by volume of O₂, 10% by volume of H₂O and the balance of N₂. The specific surface is then measured in accordance with the BET measurement method explained in the above.

### Other Conditions

The cerium oxide particles have also been aged at 700° C. and 900° C. for 16 hours under a gaseous atmosphere containing 10% by volume of O₂, 10% by volume of H₂O and the balance of N₂.

### Example 1 (According to the Invention)

10 kg of a ceric nitrate solution in terms of CeO₂ containing 94.3 mol % tetravalent cerium ions was measured out, and adjusted to a total amount of 200 L with deionized water. This corresponds to 9430 g of Ce^{IV} and 570 g of Ce^{III} (expressed in terms of CeO₂). The ceric nitrate solution was obtained according to FR 2570087. The obtained solution S was heated to 100° C., maintained at this temperature for 30 minutes, and allowed to cool down to the room temperature, to thereby obtain a suspension.

After the solid has settled in the tank, the mother liquor was removed on the top (quantity of removed liquid=156 L; this corresponds roughly to 78% of the liquid present in the tank). The total volume of the medium was then adjusted to 200 L by addition of deionized water. Calculations lead to a decrease ratio R of 38%. Indeed, from formula on page 10: A=10 000 g; B=94.3 mol %; C=20.68 mol=>one can deduce D=249.8 mol. Here, E=G=200 L. The mother liquor removed was analyzed and exhibits a concentration of 1 mol/L. One can then deduce F=249.8 mol−156 (L)×1 (mol/L)=93.8 mol. R=(93.8/200)/(249.8/200)×100=38%.

After the removal of the mother liquor, a solution of trivalent Ce^{III} cations in a form of nitrate (Ce(NO₃)₃) was added (437.9 g in terms of oxide) so as to control the amount of trivalent Ce^{III} cations to a value α=Ce^{III}/total Ce=5.7 mol %. Then the cerium suspension was maintained at 120° C. for 2 hours, allowed to cool, and neutralized to pH 8.9 with aqueous ammonia.

After the solid has settled in the tank, the mother liquor was removed on the top (quantity of removed liquid: 100 L). Calculations lead to a decrease ratio R′ of 50%. The slurry was then maintained at 120° C. for 1 hour, and allowed to cool. To the slurry resulting from the heating, 2.5 kg of lauric acid (texturing agent/CeO₂=25% by weight) was added, and stirred for 60 minutes.

The obtained slurry was subjected to solid-liquid separation through a filter pressing to obtain a filter cake. The cake was then calcined in the air at 400° C. for 10 hours to obtain the cerium oxide particles.

### Example 2 (According to the Invention)

Cerium oxide particles were prepared exactly in the same way as in example 1 except that:
10 kg of a ceric nitrate solution in terms of CeO₂ containing 92.9 mol % instead of 94.3 mol % tetravalent cerium ions was measured out;
the quantity of mother liquor removed=150 L (calculations lead to a decrease of R=41% instead of 38%);
a solution of trivalent Ce^{III} cations was not added after the mother liquor was removed so that the molar ratio α=Ce^{III}/total Ce was decreased to 2.0 mol %.

### Example 3 (According to the Invention)

50 g of a ceric nitrate solution in terms of CeO₂ containing 94.1 mol % tetravalent cerium ions was measured out, and adjusted to a total amount of 1 L with deionized water. The obtained solution S was heated to 100° C., maintained at this temperature for 30 minutes, and allowed to cool down to the room temperature, to thereby obtain a cerium suspension.

After the solid has settled in the tank, the mother liquor was removed from the cerium suspension thus obtained (quantity removed: 0.75 L), the total volume was adjusted to 1 L with deionized water. Calculations lead to a decrease ratio R of 41%. The molar ratio Ce^{III}/total Ce (a) was decreased to 1.6 mol %.

Then the cerium suspension was maintained at 120° C. for 2 hours, allowed to cool, and neutralized to pH 8.5 with aqueous ammonia. After the solid has settled in the tank, 0.5 L of the mother liquor was removed from the basic slurry thus obtained. Calculations lead to a decrease ratio R′ of 50%. The slurry was then maintained at 100° C. for 1 hour, and allowed to cool. To the slurry resulting from the heating, 11.8 g of lauric acid was added (texturing agent/CeO₂=25% by weight), and stirred for 60 minutes.

The obtained slurry was subjected to solid-liquid separation through a Nutsche filter to obtain a filter cake. The cake was calcined in the air at 400° C. for 10 hours to obtain the cerium oxide particles.

### Example 4 (Comparative)

Cerium oxide particles were prepared in accordance with the method of example 1 disclosed in WO 2016/075177. 50 g of a ceric nitrate solution in terms of CeO₂ containing not less than 90 mol % tetravalent cerium cations was measured out, and adjusted to a total amount of 1 L with deionized water. The obtained solution was heated to 100° C., maintained at this temperature for 30 minutes, and allowed to cool down to 25° C., to thereby obtain a suspension.

After the mother liquor was removed from the cerium suspension thus obtained, the total volume was adjusted to 1 L with deionized water; concentration of anions was hence decreased by 44%, in comparison with anions comprised in the liquid medium after heating.

Then the cerium suspension was maintained at 120° C. for 2 hours, allowed to cool, and neutralized to pH 8.5 with aqueous ammonia. To the slurry resulting from the neutralization, 12.5 g of lauric acid was added, and stirred for 60 minutes. The obtained slurry was subjected to solid-liquid separation through a Nutsche filter to obtain a filter cake. The cake was calcined in the air at 300° C. for 10 hours to obtain particles of cerium oxide.

### Example 5 (Comparative)

A ceric oxide powder was prepared in accordance with the method disclosed as example 1 of WO 2017/198738. 50 g of a ceric nitrate solution in terms of CeO₂ containing not less than 90 mol % tetravalent cerium cations was measured out, and adjusted to a total amount of 1 L with deionized water. The obtained solution was heated to 100° C., maintained at this temperature for 30 minutes, and allowed to cool down to 25° C., to thereby obtain a cerium suspension.

After the mother liquor was removed from the cerium suspension thus obtained, the total volume was adjusted to 1 L with deionized water; concentration of anions is hence decreased by 44%, in comparison with anions comprised in the liquid medium after heating. After the removal of the mother liquor, a solution of trivalent Ce^{III} cations in a form of nitrate (Ce(NO₃)₃) was added so as to control the amount of trivalent Ce^{III} cations to a value α=Ce^{III}/total Ce=6.0 mol %.

Then the cerium suspension was maintained at 120° C. for 2 hours, allowed to cool, and neutralized to pH 8.5 with aqueous ammonia. The obtained solution was heated to 120° C., maintained at this temperature for 1 hour, and allowed to cool down to 25° C., thereby obtaining a slurry. The obtained slurry was subjected to solid-liquid separation through a Nutsche filter to obtain a filter cake. The cake was calcined in the air at 400° C. for 10 hours to obtain cerium oxide powder.

### Example 6 (Comparative)

A ceric oxide powder was prepared in accordance with the method disclosed as example 2 of WO 2017/198738. A cerium oxide powder was prepared in the same way as in example 5 except that after the thermal aging at the temperature of 120° C. for 1 hour, the obtained slurry was allowed to cool down to 40° C., and then, lauric acid (12.5 g) was added to the slurry.

### Example 7 (Comparative)

A ceric oxide powder was prepared in accordance with the method disclosed as example 3 of WO 2017/198738. A cerium oxide powder was prepared in the same way as in Example 6 except that the amount of trivalent Ce^{III} cations based on the total amount of cerium was controlled to be 8.0 mol %, instead of 6.0 mol %.

Table 1 and Table 2 provide a comparison between cerium oxide particles prepared according to this application on the one hand and cerium oxide particles prepared according to WO 2016/075177 (ex. 4) and WO 2017/198738 on the other hand (ex. 5-7).

TABLE 1

| | | | | comparative examples | | | |
|---|---|---|---|---|---|---|---|
| | | | | 4 | | | |
| | | | | according | 5 | 6 | 7 |
| | according to the | | | to WO | according | | |
| | invention | | | 2016/ | to WO 2017/ | | |
| Examples | 1 | 2 | 3 | 075177 | 198738 | | |
| D50 (μm) | 1.4 | 2.3 | 2.2 | 2.8 | 4.5 | 1.2 | 3.6 |
| D10 (μm) | 0.9 | 1.5 | 1.3 | 1.8 | 2.8 | 0.7 | 2.1 |
| D90 (μm) | 2.2 | 3.8 | 3.7 | 4.6 | 7.0 | 1.9 | 5.8 |
| S_{BET} 700° | 91 | 100 | 99 | / | 92 | 89 | 84 |
| C./16 h/ | | | | | | | |
| hydrothermal | | | | | | | |
| conditions | | | | | | | |
| S_{BET} 800° | 78 | 76 | 75 | 72 | 65 | 65 | 68 |
| C./16 h/ | | | | | | | |
| hydrothermal | | | | | | | |
| conditions | | | | | | | |
| S_{BET} 900° | 45 | 39 | / | 37 | 37 | 41 | 45 |
| C./16 h/ | | | | | | | |
| hydrothermal | | | | | | | |
| conditions | | | | | | | |
| S_{BET} 900° | 71 | 67 | 68 | 63 | 57 | 64 | 63 |
| C./4 h/air | | | | | | | |
| S_{BET} 900° | 52 | 43 | 42 | 41 | 43 | 49 | 48 |
| C./24 h/air | | | | | | | |

S_{BET}: specific surface areas (BET) in m²/g

As can be seen in Table 1, the cerium oxide particles according to the invention exhibit a better specific surface after treatment under hydrothermal conditions. They also exhibit a better thermal resistance at 900° C. for 4 hours.

TABLE 2

| | according to the | | | | | | |
|---|---|---|---|---|---|---|---|
| | invention | | | comparative examples | | | |
| Examples | 1 | 2 | 3 | 4 | 5 | 6 | 7 |
| r_{400° C.} (%) | 1.8 | 1.5 | 1.5 | 1.3 | 1.1 | 1.3 | 1.2 |
| r_{600° C.} (%) | 9.8 | 8.5 | 8.8 | 8.0 | 7.5 | 7.8 | 7.9 |
| r_{900° C.} (%) | 24.5 | 22.7 | 23.5 | 20.5 | 21.9 | 19.8 | 20.3 |

As can be seen in Table 2, the cerium oxide particles according to the invention also exhibit better reducibilities.

This is also visible on FIG. 1 which provides the TPR curves for the cerium oxides of ex. 1, ex. 4 and ex. 5. It is visible that the cerium oxide of ex. 1 consumes more hydrogen than the two other oxides of ex. 4 and ex. 5, in particular between 50° C. and 600° C.

### Example 8: LNT Catalytic Composition

A LNT catalytic composition could be prepared by calcining in air at 550° C. a mixture having the following composition: cerium oxide of one of examples 1-3 (32.5 weight %), barium carbonate (22.5 weight %), magnesia (7.1 weight %), zirconia (3.6 weight %), platinum (0.8 weight %) and palladium (0.12 weight %) and γ-alumina (complement to 100%). Pd in the form of palladium nitrate and Pt in the platinum amine could be introduced onto a mixture of cerium oxide, barium carbonate and alumina by wetness impregnation.

1. A lean NOₓ trap catalytic composition, the composition comprising cerium oxide exhibiting:
a specific surface area (BET) after ageing at 800° C. for 16 hours, under a gaseous atmosphere containing 10% by volume of O₂, 10% by volume of H₂O and the balance of N₂, of at least 75 m²/g;
or
a specific surface area (BET) after ageing at 700° C. for 16 hours, under a gaseous atmosphere containing 10% by volume of O₂, 10% by volume of H₂O and the balance of N₂, of at least 97 m²/g.

2. The lean NOₓ trap catalytic composition according to claim 1, wherein the cerium oxide exhibits a specific surface area (BET) after ageing at 800° C. for 16 hours, under a gaseous atmosphere containing 10% by volume of O₂, 10% by volume of H₂O and the balance of N₂, between 75 and 80 m²/g.

3. The lean NOₓ trap catalytic composition according to claim 1, wherein the cerium oxide exhibits a specific surface area (BET) after ageing at 700° C. for 16 hours, under a gaseous atmosphere containing 10% by volume of O₂, 10% by volume of H₂O and the balance of N₂, of at least 98 m²/g.

4. The lean NOₓ trap catalytic composition according to claim 1, wherein the cerium oxide exhibits a specific surface area (BET) after ageing at 700° C. for 16 hours, under a gaseous atmosphere containing 10% by volume of O₂, 10% by volume of H₂O and the balance of N₂, between 97 and 102 m²/g.

5. The lean NOₓ trap catalytic composition according to claim 1, wherein the cerium oxide exhibits a specific surface area (BET) after ageing at 900° C. for 16 hours, under a gaseous atmosphere containing 10% by volume of O₂, 10% by volume of H₂O and the balance of N₂, of at least 39 m²/g.

6. The lean NOₓ trap catalytic composition according to claim 1, wherein the cerium oxide exhibits a specific surface area (BET) after ageing at 900° C. for 16 hours, under a gaseous atmosphere containing 10% by volume of O₂, 10% by volume of H₂O and the balance of N₂, of at most 50 m²/g.

7. The lean NOₓ trap catalytic composition according to claim 1, wherein the cerium oxide exhibits a specific surface area (BET) after calcination in air at 900° C. for 4 hours of at least 65 m²/g.

8. The lean NOₓ trap catalytic composition according to claim 1, wherein the cerium oxide exhibits a specific surface area (BET) after calcination in air at 900° C. for 4 hours, of at most 75 m²/g.

9. The lean NOₓ trap catalytic composition according to claim 1, wherein the cerium oxide exhibits a specific surface area (BET) after calcination in air at 900° C. for 24 hours, between 40 and 60 m²/g.

10. The lean NOₓ trap catalytic composition according to claim 1, wherein the cerium oxide exhibits a reducibility rate r_{900° C.} comprised between 20.0% and 25.0% after calcination in air at 900° C. for 4 hours, r_{900° C.} being defined by:
red_{900° C.}=V_{H2 from 50° C. to 900° C.}/V_{theoretical}×100 (Ia)
wherein:
V_{H2 from 50° C. to 900° C.} corresponds to the volume of hydrogen consumed by the cerium oxide between 50° C. and 900° C.;
V_{theoretical} corresponds to the theoretical amount of hydrogen consumed by cerium oxide.

11. The lean NOₓ trap catalytic composition according to claim 1, wherein the cerium oxide exhibits a reducibility rate r_{600° C.} comprised between 8.0% and 12.0% after calcination in air at 900° C. for 4 hours, r_{600° C.} being defined by:
red_{600° C.}=V_{H2 from 50° C. to 600° C.}/V_{theoretical}×100 (Ib)
wherein:
V_{H2 from 50° C. to 600° C.} corresponds to the volume of hydrogen consumed by the cerium oxide between 50° C. and 600° C.;
V_{theoretical} corresponds to the theoretical amount of hydrogen consumed by cerium oxide.

12. The lean NOₓ trap catalytic composition according to claim 1, wherein the cerium oxide exhibits a reducibility rate r_{400° C.} comprised between 1.5% and 2.0%, more particularly between 1.5% and 1.8%, after calcination in air at 900° C. for 4 hours, r_{400° C.} being defined by:
red_{400° C.}=V_{H2 from 50° C. to 400° C.}/V_{theoretical}×100 (Ic)
wherein:
V_{H2 from 50° C. to 400° C.} corresponds to the volume of hydrogen consumed by the cerium oxide between 50° C. and 400° C.;
V_{theoretical} corresponds to the theoretical amount of hydrogen consumed by cerium oxide.

13. The lean NOₓ trap catalytic composition according to claim 1, further comprising:
at least one platinum group metal (PGM);
at least one inorganic oxide;
at least one element (E) in the form of an oxide, an hydroxide and/or a carbonate, the element (E) being selected in the group consisting of the alkaline earth metals, the alkali metals or a combination thereof.

14. A LNT catalytic composition comprising:
a cerium oxide exhibiting:
a reducibility rate r_{600° C.} between 8.0% and 12.0%; and/or
a reducibility rate r_{900° C.} between 20.0% and 25.0%; and/or
a reducibility rate r_{400° C.} between 1.5% and 2.0%;
these reducibility rates being measured after calcination of the cerium oxide in air at a temperature of 900° C. for 4 hours;
at least one platinum group metal (PGM);
at least one inorganic oxide;
at least one element (E) in the form of an oxide, an hydroxide and/or a carbonate, the element (E) being selected in the group consisting of the alkaline earth metals, the alkali metals or a combination thereof.

15. The LNT catalytic composition according to claim 13, wherein element (E) is barium.

16. The LNT catalytic composition according to claim 13, wherein the inorganic oxide is selected from the group consisting of alumina optionally stabilized by lanthanum and/or praseodymium; ceria; magnesia; silica; titania; zirconia; tantalum oxide; molybdenum oxide; tungsten oxide; and composite oxides thereof.

17. A process for treatment of an exhaust gas released by the internal combustion engine of a vehicle to decrease its NOₓ content, the process comprising contacting the exhaust gas with the LNT catalytic composition of claim 13.

18. A process for treatment of an exhaust gas released by the internal combustion engine of a vehicle to decrease its NOₓ content, the process comprising contacting the exhaust gas with the LNT catalytic composition of claim 14.
